(19) United States
(12) Patent Application Publication
(10) Pub. No.: US 2004/0103586 A1
(43) Pub. Date: Jun. 3, 2004

(54) Door Wing or Window Wing Arrangement

(75) Inventor: Dirk Schneider, Bad Oeynhausen (DE)

Correspondence Address: GUDRUN E. HUCKETT, LONSSTR. 53, WUPPERTAL, 42289, DE

(73) Assignee: SOLARLUX ALUMINIUM SYSTEME GMBH, Bissendorf (DE)

(21) Appl. No.: 10/604,101

(22) Filed: Jun. 26, 2003

(30) Foreign Application Priority Data
Jun. 28, 2002 (DE) 102 29 228.0

(51) Int. Cl. E05C 17/00

(52) U.S. Cl. 49/394

(57) ABSTRACT

A wing arrangement has a window or door frame and a wing of a door or a window secured in the window or door frame so as to allow opening and closing of the wing. A locking device is provided at the opening side of the wing and has at least one push rod for locking the wing in the window or door frame. The locking device has a locking bar and an actuating element for the locking bar supported on a wing frame of the wing. The locking bar engages the window or door frame or a neighboring wing framelocking the wing. The wing frame has an open profile section open to the opening side into which the locking bar is inserted at any desired location. The actuating element is a driver mounted on the push rod in a matching position relative to the locking bar.

### BACKGROUND OF INVENTION

1. Field of the Invention

The invention relates to a wing arrangement for wings of windows or doors, which are secured in a usually peripherally extending frame, the so-called window frame or door frame, and can be opened. The wing arrangement is suitable, in particular, for use in folding devices comprising a locking device at the opening side. The wing has a wing frame provided with at least one locking bar and an actuating element for the locking bar, wherein the locking bar engages the window or door frame or the wing frame of a neighboring wing for locking the wing.

2. Description of the Related Art

Such wing arrangements are particularly important in connection with folding devices which have several wings connected to a wing chain and guided at the top and at the bottom in guide rails. When closing such folding devices, the individual wings are usually locked by bascule-type locks by rotation of an actuating handle. The actuator handle acts usually by means of a reversing drive on two push rods which in the pushing direction move at the top and at the bottom a locking bar out of the window wing frame or door wing frame into the outer window or door frame and lock the wing in this way. In folding devices, the fixation of neighboring wings relative to one another within one wing chain is realized by means of the hinges connecting the wings so that upon bending caused by wind forces no relative movement of the wing profile relative to one another occurs and in this way an excellent sealing action is ensured. This is different in the case of an outer wing which is connected laterally neither to an additional wing nor to a window or door frame. When the wing is locked only at the top and at the bottom, between this wing and the lateral window or door frame a relative movement occurs at the opening side when wind forces act on the folding device because the wing will bend under the load of the wind forces while the window or door frame remains rigid since it is secured to the rigid building part. This relative movement is greatest at half the height of the wing and increases with increasing wing height for a constant wind load. This has the result that the seals provided at these locations no longer uniformly provide contact, and the sealing function is reduced in this way. In order to correct this problem, the wing at the opening side is locked at the window or door frame by means of at least one additional locking bar.

In conventional window wings, pins are usually mounted on the push rods which, when locking the wing, engage corresponding abutments of the window or door frame. Because of the usually desired minimal frame width, these pins can be configured to project only slightly. In the case of folding devices, this projection is insufficient for ensuring a safe locking action when positive or negative expansions of the wing chain occur. This type of additional locking is therefore generally only used single-wing windows or doors.

In practice, systems are used in the case of folding devices in which at the opening side of the wing to be opened a lateral locking bar is integrated into the case of the lock of the reversing drive for the upper and the lower locking bars; the lateral locking bar is actuated directly by pivoting the handle. Disadvantages in this connection are that the arrangement of the locking bar must be provided in the area of the case of the lock (lock case) and, moreover, that no additional locking points at the opening side are possible. For example, in the case of very tall wings, the handle and also the case of the lock are located relatively low on the wing, but the locking action at the opening side would be desirable at a much higher location, i.e., near the center of the wing.

Lastly, entry doors for homes and apartments are known which have, in addition to the main locking bar arranged in the lock case, additional locking bars at the opening side; the additional locking bars are connected by means of a common lock plate to the case of the lock. The number and the spacing of these additional locking means is however unchangeable because of their attachment on the lock plate. Therefore, different configurations with predetermined dimensions can be realized only by designing and storing many variants; this results in increased storage expenditures.

### SUMMARY OF INVENTION

It is an object of the present invention to provide a door or window wing arrangement with a locking device which can ensure in a simple way an excellent sealing action even when exposed to wind load (forces).

In accordance with the present invention, this is achieved in that the locking bar is inserted into an open profile section of the wing frame, open toward the opening side, in any suitable position and is actuated by means of a driver mounted on the push rod in a matching position allowing actuation of the locking bar.

By employing an open profile section of the wing frame, which is open to the opening side of the wing, the locking bar can be inserted in any suitable position. It is then necessary to mount a driver on the push rod at a position which matches that of the locking bar for proper cooperation between the locking bar and the driver so that the locking bar can be actuated. In this way, without requiring complex storing of component variants for each wing arrangement, a locking device can be provided individually at any desired position or at several desired positions where otherwise impermissible relative movements between the wing and the window or door frame would result because of wind forces. The position of the locking bar or locking bars is entirely independent of the arrangement of the handle or of the drive means for the push rods. Moreover, any suitable number of locking bars can be used. The locking device can also be used for retrofitting doors or windows because it is only necessary to mount the driver on the provided push rod and to insert the locking bar into the open profile section that is open toward the opening side. Mounting is simplified in particular when the push rod, as is preferred, is arranged such in the window frame that it is accessible from the opening side.

The wing arrangement according to the invention is employed preferably for providing additional locking at the opening side of the window or door wings where locking is effected already at the topside and/or the bottom side by one or several additional locking bars which can be moved in the push direction of the push rods out of the wing frame. The push rod, which is provided anyway for the purpose of actuating the upper and/or the lower locking bar, can be used in this connection by mounting the driver for actuating the inventive locking bar arranged according to the invention on the opening side of the wing frame.

### BRIEF DESCRIPTION OF DRAWINGS

FIG. 1 is a section of a wing frame and lateral door/window frame of a wing arrangement according to the invention with the locking device in the locked position.

FIG. 2 shows the object of FIG. 1 with the wing in the open position and the locking device unlocked.

FIG. 3a shows schematically a side view in the direction III of FIG. 1 of the locking device in a first position; the correlated handle position is shown to the right at a reduced scale.

FIG. 3b shows schematically a side view in the direction III of FIG. 1 of the locking device in a second position; the correlated handle position is shown to the right at a reduced scale.

FIG. 3c shows schematically a side view in the direction III of FIG. 1 of the locking device in a third position; the correlated handle position is shown to the right at a reduced scale.

FIG. 3d shows schematically a side view in the direction III of FIG. 1 of the locking device in a fourth position; the correlated handle position is shown to the right at a reduced scale.

FIG. 3e shows schematically a side view in the direction III of FIG. 1 of the locking device in a fifth position; the correlated handle position is shown to the right at a reduced scale.

FIG. 3f shows schematically a side view in the direction III of FIG. 1 of the locking device in a sixth position; the correlated handle position is shown to the right at a reduced scale.

FIG. 4a is a first perspective view of the locking device.

FIG. 4b is a second perspective of the locking device with the lock case indicated in dashed lines.

FIG. 4c is a third perspective view of the locking parts of the locking device.

### DETAILED DESCRIPTION

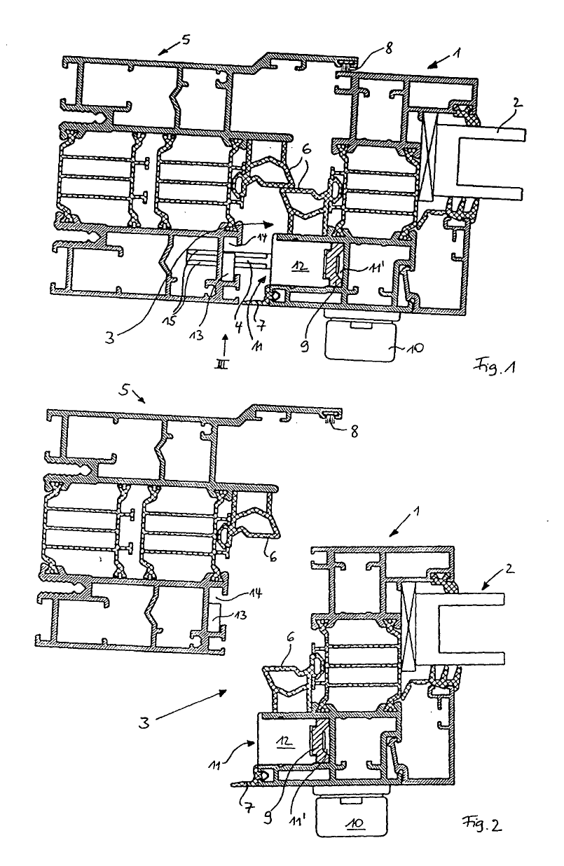

The section view of FIG. 1 shows only partially a wing frame 1 with a double window pane 2. At its opening side 3, the wing is locked by a locking bar 4 in a window or door frame 5. Elastic seals 6, a sealing lip 7, and a brush seal 8 provide protection against draft in the closed state of the wing. According to the invention, the wing frame 1 and the window or door frame 5 must not be configured to extend completely about the periphery. For example, it is sufficient when the frames extend only on the opening side 3. The actuation of the locking bar 4 is realized by means of a push rod 9 which is movable perpendicularly to the plane of illustration by means of a handle 10 within an open profile section 11 of the wing frame 1 that opens to the opening side 3. The profile section 11 is groove-shaped and the push rod 9 extends along the bottom 11′ of the profile section groove (11). The locking bar 4 is also inserted into this profile section groove 11 in front of the push rod 9 and secured in a lock case 12. This arrangement is mechanically simple and can be produced inexpensively while enabling insertion of one or several locking bars even in the case of a completely mounted wing arrangement, if necessary, also by retrofitting the wing.

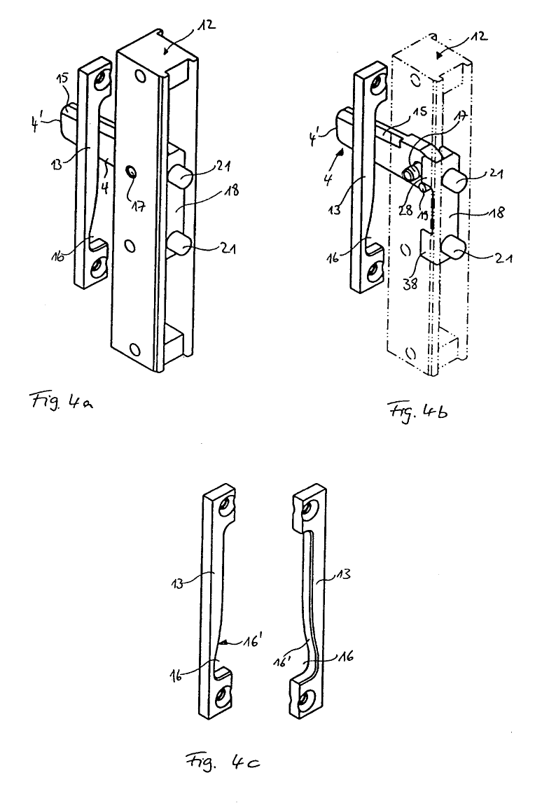

In the closed state, the locking bar 4, as illustrated, engages the window or door frame 5 or, alternatively, the wing frame of a neighboring wing. The engaging action and the securing action of the locking device can be improved when the window or door frame 5 (or a neighboring wing frame) has inserted therein a locking part 13 which is engaged by the locking bar 4. The locking part 13 is preferably inserted into a continuous profile groove 14 of the window or door frame 5 or of the neighboring wing frame; this significantly facilitates mounting. The locking bar 4 or the locking part 13 (or both elements) can have a contour which is beneficial for the engaging action of the locking bar 4. In the illustrated embodiment, this is realized by means of upper slanted portions 15 of the locking bar 4 (see, in particular, FIG. 1 and FIGS. 4a, 4b) as well as a widened portion 16 of the locking part 13 at the bottom side provided with a sliding slant 16′ (see FIG. 4c). As illustrated in FIGS. 1 and 2, the locking part 13 can be configured to be present only on one side so as to extend only to one side of the locking bar 4, for example, because of a minimal width of the profile groove 14. Of course, a configuration providing the locking part 13 on both sides, optionally in a configuration consisting of two parts as illustrated in FIG. 4c, is possible also.

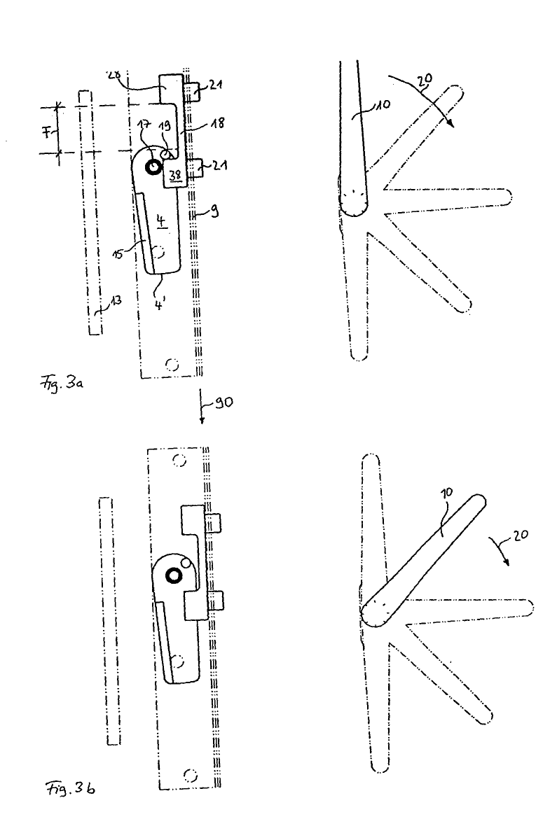

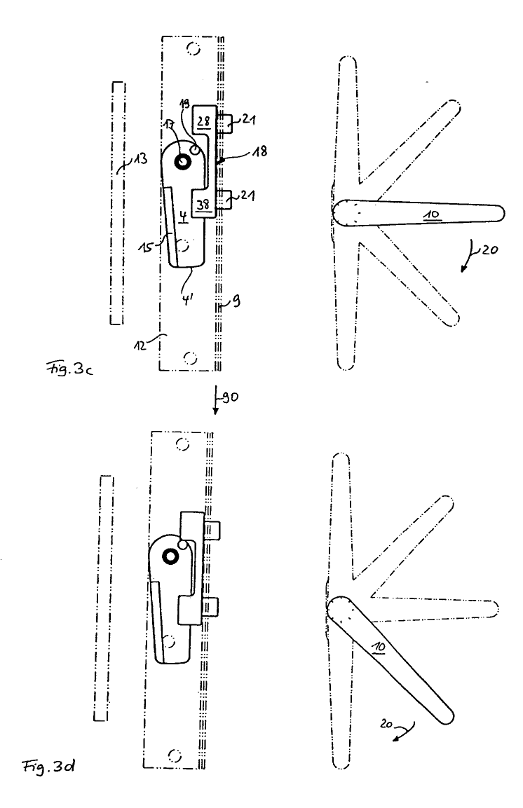

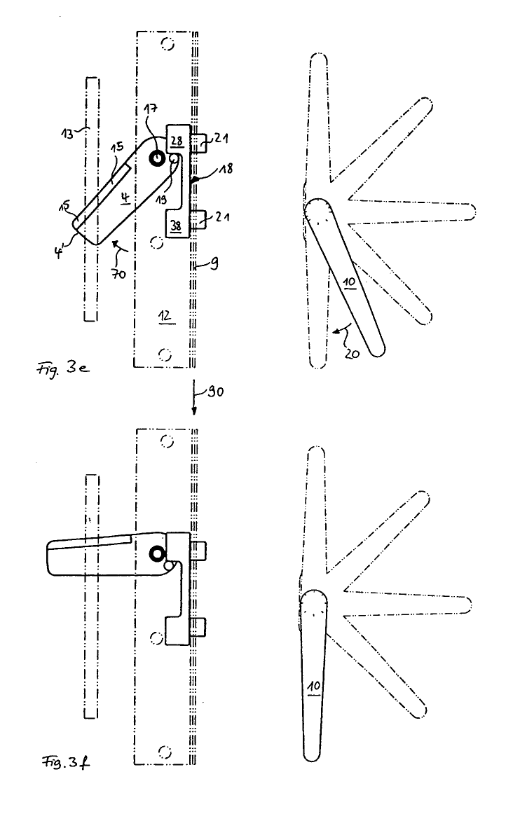

The precise configuration of the locking device of the wing arrangement according to the invention as well as its function are detailed in FIGS. 3 and 4. In FIGS. 3a through 3f, one locking position is illustrated at a reduced scale, respectively, together with the corresponding position of the actuation handle. FIG. 3a shows the locking bar 4 in the open, i.e., unlocked position. The locking bar 4 is configured as a pivot element which is pivotable about a rotary bearing 17. The configuration as a pivot element is advantageous because the locking element 4 in the open position requires only a minimal amount of space and the wing frame 1 is not widened unnecessarily. The incompletely illustrated push rod 9 is illustrated by three dash-dotted lines and has a driver 18 which acts on an engagement element 19 of the locking bar 4 for locking and unlocking the wing; the engagement element 19 is embodied as an engagement bolt 19. The illustrated driver 18 has a locking driver member 28 and an unlocking driver member 38. Advantageously, both are connected to one another to form a monolithic part. Upon actuation of the handle 10 in the direction of arrow 20, the push rod 9 is moved downwardly in the direction of arrow 90. The driver 18 secured thereon follows this movement as illustrated in the following drawings FIGS. 3b through 3f. After a certain ineffective travel stroke F (FIGS. 3b and 3c) of the locking driver member 28 has been performed, the locking driver member 28 in the position according to FIG. 3d begins to act on the engagement bolt 19 so that the latter as well as the locking bar 4 are pivoted about the rotary bearing 17 in the direction of arrow 70 and the locking bar 4 reaches the position illustrated in FIG. 3f, in which it engages the locking part 13. This position is also illustrated in a perspective view in FIGS. 4a and 4b.

For unlocking the wing, the movement illustrated in FIGS. 3a through 3f is carried out in reverse order (FIGS. 3f through 3a) counter to the direction of arrows 20, 90, 70. The unlocking driver member 38 acts on the underside of the engagement bolt 19 of the locking element 4 and effects a return pivoting action and unlocking of the locking bar 4, even if it is jammed, for example, and, for this reason, cannot drop back by its own weight into the open position of FIG. 3a. It is also possible to configure a corresponding wing arrangement exclusively with a locking driver member 28 or an unlocking driver member 38, respectively. For example, the locking element 4 could be spring biased in its locked position so that only unlocking by the unlocking driver member 38 would have to be effected. In the reverse situation, prestressing into the unlocked position is possible also.

In the illustrated embodiment, the locking driver member 28 is spaced from the engagement bolt 19 by an ineffective travel stroke F when in the completely open position (FIG. 3a). This has the effect that the push rod 9 is moved from the position of FIG. 3a first by the travel stroke F before it changes the position of the locking bar 4. In this way, a vertical locking bar provided at the lower end of the push rod 9 can be extended so that the wing is already secured on the window or door frame 5. A corresponding vertical locking bar can also be provided at the top. In this way, the force which is still required for acting on the pivoting locking bar 4 and the wear of the locking device and of the reversing drive that is usually present are reduced. Such a configuration can be realized particularly well in the configuration of the engagement element as a concentrically arranged engagement bolt 19 because the required travel stroke of the engagement bolt 19 can be very small in comparison to the ratio of the pivot movement travel carried out by the tip 4′ of the locking bar 4. When the driver 18 has a locking driver member 28 and also an unlocking driver member 38, they are preferably both spaced apart from one another at least by the ineffective travel stroke F. In the illustrated embodiment, the spacing of the locking driver member 28 from the unlocking driver member 38 matches the free travel stroke F plus the thickness of the engagement bolt 19 in the longitudinal direction 90 of the push rod 9.

Particularly advantageous with respect to mounting is the illustrated configuration in which the driver member 18 is simply inserted by means of two projections 21 into recesses (not illustrated) provided on the push rod 9. In this way, a simple mounting of the locking device, when a push rod is already present, can be realized in a retrofitting operation because it is only necessary to provide a corresponding bore or bores in the push rod which can be produced on site at the desired location without needing complicated tools, for example, simply by using a hand-hand cordless drill. The driver 18 inserted into the push rod 9 cannot fall out of the push rod 9 without this requiring additional attachment means because of the locking bar 4 arranged in front of it. Only the locking bar 4 must be fastened, for example, by means of its lock case 12, on the profile section of the wing, for example, by screwing.

Inasmuch as the profile section groove 11 that is open to the opening side of the wing frame 1 is unpleasant visually or disturbing in any other way, it can be covered outside of the area of the locking bar 4 underneath or above a possibly present lock case 12 by covers, not illustrated, which can be cut to length as needed on site. In any case, it is no longer required to store a plurality of different lock plates for different locking bar positions as is the case in the door locking devices with multiple lock function described in the prior art.

The wing arrangement according to the invention is thus adjustable in a technically simple way to the respective requirements of different applications in order to ensure at all times an optimal sealing function. When used as an additional locking means, an improved protection against burglary is provided also.

While specific embodiments of the invention have been shown and described in detail to illustrate the inventive principles, it will be understood that the invention may be embodied otherwise without departing from such principles.

What is claimed is:

1. A wing arrangement comprising:
a window or door frame (5);
a wing of a door or a window secured in the window or door frame (5) so as to allow opening and closing of the wing at an opening side (3) of the wing (1);
a locking device provided at the opening side (3) of the wing and comprising at least one push rod (9) for locking the wing in the window or door frame (5);
wherein the locking device further comprises at least one locking bar (4) and an actuating element (18) acting on the locking bar (4);
wherein the wing has a wing frame (1) and wherein the at least one locking bar (4) and the actuating element (18) are supported on the wing frame (1);
wherein the at least one locking bar (4) is configured to engage the window or door frame (5) or a neighboring wing frame of a neighboring wing for locking the wing;
wherein the wing frame (1) has an open profile section (11) open to the opening side (3);
wherein the at least one locking bar (4) is inserted into the open profile section (11) of the wing frame (1) at any desired location;
wherein the actuating element (18) is a driver mounted on the at least one push rod (9) in a matching position relative to the at least one locking bar (4) for actuating the at least one locking bar (4).

2. The wing arrangement according to claim 1, wherein the at least one push rod (4) is arranged on the wing so as to be accessible from the opening side (3) of the wing.

3. The wing arrangement according to claim 1, wherein the locking device comprises a locking element and wherein the at least one push rod (9) acts on the locking element to move the locking element in a pushing direction (90) of the push rod (9) out of the wing frame (1) for locking the wing frame (1) in the window or door frame (5).

4. The wing arrangement according to claim 1, wherein the at least one locking bar (4) comprises a rotary bearing (17) and a pivot element mounted rotatably on the rotary bearing (17).

5. The wing arrangement according to claim 1, wherein the driver (18) comprises a locking driver member (28) and wherein the at least one locking bar (4) has an engagement element (19) interacting with the locking driver member (28) for effecting locking of the wing.

6. The wing arrangement according to claim 5, wherein the locking driver member (28) in an unlocked position of the wing is spaced from the engagement element (19) of the at least one locking bar (4) in a longitudinal direction of the at least one push rod (9) by a spacing matching an ineffective travel stroke (F) of the locking driver member (28).

7. The wing arrangement according to claim 6, wherein the driver (18) comprises an unlocking driver member (38) interacting with the engagement element (19) of the at least one locking bar (4).

8. The wing arrangement according to claim 7, wherein the locking driver member (28) and the unlocking driver member (38) are spaced apart from one another at least by a spacing matching the ineffective travel stroke (F) of the locking driver member (28).

9. The wing arrangement according to claim 7, wherein the locking driver member (28) and the unlocking driver member (38) are connected to one another and form a monolithic part.

10. The wing arrangement according to claim 5, wherein the engagement element (19) of the at least one locking bar (4) is an engagement bolt eccentrically arranged relative to the rotary bearing (17) of the at least one locking bar (4).

11. The wing arrangement according to claim 1, wherein the driver (18) is inserted into the at least one push rod (9).

12. The wing arrangement according to claim 1, wherein the locking device further comprises a locking part (13) inserted into the window or door frame (5) or the neighboring wing frame of the neighboring wing, wherein the at least one locking bar (4) lockingly engages the locking part (13).

13. The wing arrangement according to claim 12, wherein the window or door frame (5) or the neighboring wing frame of the neighboring wing has an at least partially continuously extending profile groove (14) for receiving the locking part (13).

14. The wing arrangement according to claim 12, wherein the wing to be opened has at the opening side (3) at least one substantially continuous profile section groove (11) having a groove bottom (11′), wherein the at least one locking bar (4) is positioned in the profile section groove (11) and the at least one push rod (9) is located at the groove bottom (11′).

15. The wing arrangement according to claim 12, wherein at least one of the at least one locking bar (4) and the locking part (13) has a contour beneficial for an engagement action between the at least one locking bar (4) and the locking part (13).

16. The wing arrangement according to claim 1, wherein the locking device comprises a lock case (12) and wherein the at least one locking bar (4) is secured in the lock case (12).

17. The wing arrangement according to claim 1, further comprising covers inserted into the open profile section (11) of the wing frame (1) outside of an area where the at least one locking bar (4) is arranged.
